(19) United States
(12) Patent Application Publication
(10) Pub. No.: US 2004/0094415 A1
(43) Pub. Date: May 20, 2004

(54) Gas sensor

(76) Inventors: Andreas Bausewein, Langenbach (DE); Rolf Bruck, Bergisch Gladbach (DE); Hans Meixner, Haar (DE); Meike Reizig, Bonn (DE)

Correspondence Address: YOUNG & THOMPSON, 745 SOUTH 23RD STREET 2ND FLOOR, ARLINGTON, VA, 22202

(21) Appl. No.: 10/381,799

(22) PCT Filed: Sep. 28, 2001
(86) PCT No.: PCT/DE01/03733

(30) Foreign Application Priority Data
Sep. 28, 2000 (DE) 100 48 195.7

(51) Int. Cl. G01N 27/26

(52) U.S. Cl. 204/424; 205/784.5

(57) ABSTRACT

The invention relates to a gas sensor (S) that comprises at least one gas-sensitive region (2) that is applied to a substrate (1), said substrate (1) being provided with at least one diffusion-open section.

### DESCRIPTION

Gas Sensor

The invention relates to a gas sensor, an application of said gas sensor and a method for gas detection.

A gas sensor for detection of a gas (“target gas”) frequently exhibits a cross-sensitivity to another gas (“interference gas”). With a chemical gas sensor based on solid-electrolyte chains or semiconducting metal oxides, for example, for a desired detection of the target gas hydrocarbon and/or nitric oxide there may be present a cross-sensitivity to a changing concentration of the interference gas O₂, such as occurs for example in an exhaust gas. This leads to a limitation in the measuring accuracy of the gas sensor or even sometimes prevents its use in an exhaust gas with an oscillating O₂ partial pressure (λ=1 regulation) if the sensor for measuring the target gases is geared toward a specific O₂ concentration.

The use of a gas sensor for detection of hydrocarbons and/or nitric oxides, particularly in exhaust gases of motor vehicles, was therefore possible hitherto only subject to the following restrictions:

Use of a means of discriminating the sensor signals according to the O₂ partial pressure prevailing at the time of the measurement, with rejection of the measurement data if the O₂ concentration CO₂ falls below or exceeds a specific tolerance range, typically 1%<CO₂<10%. What is necessary for this is a reference sensor which reacts only to oxygen and which is present at the same location as the actual gas sensor.

Use of an electrochemical O₂ pump cell for preparation of the measured gas by setting of a defined O₂ concentration in the measured gas locally in the area of the gas sensor. However, this concept leads to complex sensor designs which possess integral cavities and channels, and which are therefore complicated and expensive to produce. Moreover, the electronic signal evaluation and control of the O₂ pump cells require a separate calibration for each sensor element produced.

The object of the present invention is to provide a means of gas detection with simplified regulation of the interference gas.

This object is achieved by a gas sensor according to claim 1, by an application according to claim 10 and by a method according to claim 11.

To this end, the gas sensor comprises at least one gas-sensitive region that is applied to a substrate. The substrate provides at least one diffusion-open section, said porous section enabling at least one interference gas to diffuse through the substrate to the gas-sensitive region.

It is not necessary in this case for the substrate to be completely open to diffusion, but it may also be open to diffusion only in one or more sections, for example in order to produce increased stability. Possible materials suitable for the substrate include e.g. Al₂O₃, Al₂MgO₄ or ZrO₂.

The gas sensor further includes all devices for operation of the gas sensor known to the person skilled in the art, such as, for example, measuring electrodes or, in the case of heated gas sensors, heating elements and/or temperature sensors.

Of course, the gas sensor may also be suitable for diffusion of a number of interference gases, the composition or presence of which depends on the individual application scenario. One such gas may be, but is not restricted to, oxygen, for example. It is also possible to expose the surface of the substrate that is opposite to the gas-sensitive region to a controlled atmosphere enriched with one or more interference gases.

The gas sensor has the advantage that it is very simply constructed and can be produced in a compact format. There is no need for special pump systems or feeder channels.

It is advantageous if the at least one diffusion-open section provided to allow diffusion is porous. It is also particularly preferred if the porosity of the substrate lies between 10% and 40%, particularly between 20% and 30%.

For more effective enrichment of the space around the gas-sensitive region, it is advantageous if a gas-tight covering layer is applied to the substrate, covering the gas-sensitive region. Of course, this gas-tight covering layer does not need to be applied only directly to the substrate, but it is also sufficient if it is applied indirectly, for example on multiple intermediate layers. The purpose of this covering layer is to protect the interference gas diffusing through the substrate to the gas-sensitive region against flows, so that it is not immediately carried away by an air stream. Rather, the space surrounding the gas-sensitive region is enriched by the interference gas to a greater extent as a result of the covering layer. To ensure that the gas to be detected, for example nitric oxide or hydrocarbon in an exhaust gas, can still reach the gas-sensitive region, an aperture is incorporated in the covering layer.

It is particularly advantageous here if the gas-sensitive region is located at the point of highest concentration of the interference gas within the covering layer. This can be achieved, for example, if the gas-sensitive region is located centrally under the covering layer and opposite the aperture. This ensures that a comparatively constant stream of interference gas is maintained from the sides within the covering layer to the center, where the gas-sensitive region and the aperture are located.

It is also preferred if a gas-permeable insulating layer is present between the gas-sensitive region and the covering layer.

Particularly preferred is a gas sensor in which the gas-sensitive region is implemented in the form of a layer made of semiconducting metal oxide, for example as a high-temperature metal oxide sensor. A heatable metal oxide sensor of this type typically includes comb-shaped measuring electrodes and a heating element, each made of platinum.

The gas sensor is typically exposed to a gas atmosphere that is to be measured, e.g. to an exhaust gas, while at the same time the interference gas can diffuse to the gas-sensitive region through the diffusion-open section of the substrate. This implicitly includes that the gas sensor is mounted in such a way that it is not completely located in the gas atmosphere that is to be measured, but borders with the surface of the substrate that is opposite the gas-sensitive region on another gas atmosphere containing the interference gas in higher concentrations, for example air.

An application of such a gas sensor is particularly useful for detection of hydrocarbons and/or nitric oxides in an exhaust gas, with at least oxygen diffusing as an interference gas through the substrate to the gas-sensitive region. With regard to exhaust gas regulation in particular, this produces an advantage compared with the existing known and complicated methods for this purpose or methods which can be used only with limitations.

It is also particularly advantageous if the gas sensor is installed in a wall of an exhaust gas pipe or another container accepting the exhaust gas. This takes place in simple fashion such that the gas sensor with its gas-sensitive region is inserted through a cutout in the exhaust gas pipe so that a surface of the substrate is still exposed to the air.

Such an integrated gas sensor is particularly favorable for exhaust gas regulation in a motor vehicle, for example as part of a lambda probe, or as part of a heating system, for example in single houses or apartment buildings or also in commercial district heating power stations.

The invention is not restricted to a specific sensor type, i.e. semiconducting and/or heatable, nor to the application of exhaust gas diagnosis. The invention is also not restricted to oxygen as an interference gas. Rather, the gas sensor can be designed and/or installed in a flexible and versatile manner according to the particular application.

In the following exemplary embodiments, the gas sensor is described schematically in greater detail with reference to a high-temperature metal oxide gas sensor for detecting hydrocarbons and/or nitric oxides in an exhaust gas.

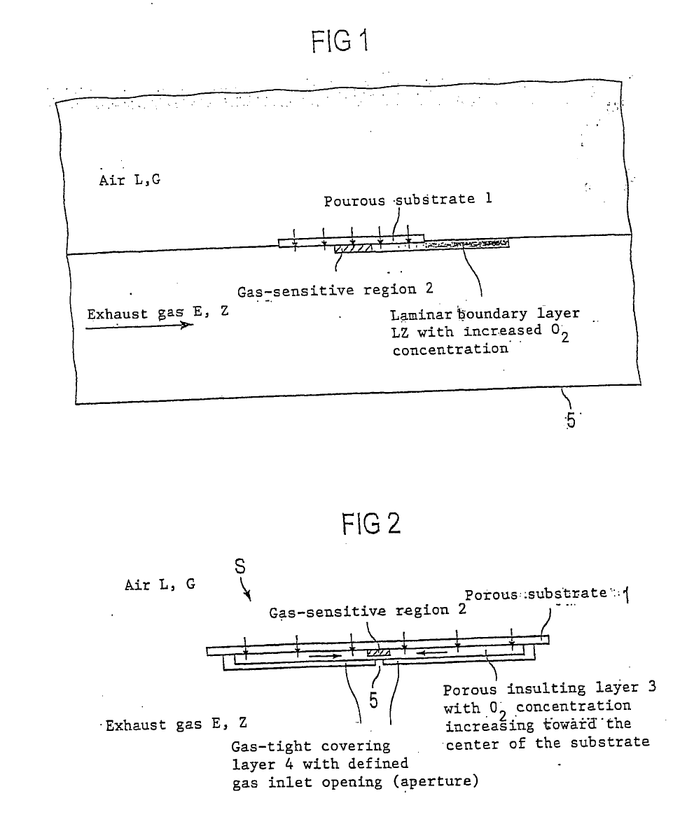

FIG. 1 shows a gas sensor installed in an exhaust gas pipe,

FIG. 2 shows this gas sensor in magnified form.

FIG. 1 shows a side-on sectional view of an exhaust gas pipe 5, within which flows an exhaust gas E (indicated by the central arrow pointing from left to right). The exhaust gas E contains hydrocarbons and/or nitric oxides as target gases Z. The exhaust gas pipe 5, in turn, is located in an ambient atmosphere made up of air L, which contains the interference gas G oxygen in higher concentration than the exhaust gas E.

Such a configuration is typical, for example in the exhaust pipe of a motor vehicle.

The gas sensor S is inserted in a cutout of the exhaust pipe 5 such that the exhaust gas E flows around the gas-sensitive region 2 of the gas sensor S. The porous substrate 1 carries the gas-sensitive region 2 and with its underside opposite to the gas-sensitive region 2 is exposed to the air L. At least the oxygen O₂ present in the air L diffuses through the porous substrate 1 to the surface exposed in the exhaust gas E (small arrows pointing from top to bottom), where it generates a laminar boundary layer LZ with an increased O₂ concentration.

With such an arrangement it is possible to perform gas detection even at low or oscillating O₂ partial pressure (λ=1-regulation) in the exhaust gas E.

The porosity of the substrate 1 is between 10 and 40%, and preferably 20% to 30%. Due to the difference in O₂ concentration, the oxygen can diffuse through the large surface area of the substrate 1 provided opposite to the gas-sensitive region 2 from the air side to the exhaust gas side of the substrate 1, with the result that the exhaust gas E is enriched with approx. 2-5% oxygen in the area of the gas-sensitive layer 2. A typical diffusion speed for the O₂ molecules is in the range of 1-10 cm/s, thus enabling a particulate stream density of approx. 1 mol.s⁻¹ cm⁻² to be attained.

FIG. 2 shows a side-on sectional view of a gas sensor S with covering layer 4.

The gas-tight covering layer 4 has a large surface area and is positioned above the gas-sensitive region 2 and filled out with a diffusion-open porous insulating layer 3. Opposite the gas-sensitive region 2, a defined gas inlet opening (aperture) 5 is incorporated in the covering layer 4.

The covering layer 4 prevents the oxygen that is diffusing in from being carried away immediately by the exhaust gas stream, which flows through the exhaust gas pipe 5 at a typical speed of 10-100 m/s. Moreover, the presence of the covering layer 4 is advantageous for supplying oxygen to the gas-sensitive region 2, because the oxygen that has diffused through the substrate 1 necessarily streams past the gas-sensitive region 2 and so is prevented from escaping prematurely into the exhaust gas E.

In this exemplary embodiment, O₂ diffuses into the insulating layer 3, within which an increasing O₂ concentration is produced toward the center of the substrate 1 (the direction of the oxygen flow in the insulating layer 3 is symbolized by the horizontal arrows).

Due to the ratio between the size of the aperture 5 compared with the surface area of the porous substrate 1 under the covering layer 4, an O₂ concentration is set at the gas-sensitive region 2, and a difference between the O₂ diffusion speed and the speed of the exhaust gas E can be evened out.

The following computation example is intended to clarify the mode of operation of the gas sensor S:

From a diffusion coefficient D of O₂ in N₂ of D=1 cm²/s and a thickness h of the substrate 1 of h=0.5 cm, it follows, with a large degree of validity of Fick's law, namely J=-D dn/dx, where dn=1 mol and dx=h, that a particulate stream J=2 mol cm⁻² s-1 is produced, the porosity of the substrate 1 not being factored in.

Assuming that an O₂ concentration CO₂=5% is required at the gas-sensitive region 2, this yields a necessary ratio of the diffused-in O₂ to the exhaust gas E of 1 to 19, or 1 to 20 in total. Applied to the diffusion speed of O₂ Of V_{diff} (O₂)=1-10 cm/s, this yields a tolerable speed of the exhaust gas E of V_{E}=0.2-2 m/s. By contrast, the real speed V_{E} of the exhaust gas E is typically 10-100 m/s; in other words, it is faster by a factor of 50.

By using a covering layer 4 with aperture 5 with a surface area of the substrate 1 of 1 cm² and a surface area of the aperture 5 of 1 mm², it is possible to achieve a significant increase in the O₂ concentration. This enables the supply of oxygen to be adjusted to the speed V_{Exhaust-gas} of the exhaust gas E.

A gas sensor S of this type is usually built using thick layer technology and contains, in addition to electrodes for determining the conductivity of the gas-sensitive region 2, a heating structure and a temperature sensor.

The substrate 1 can be integrated with little effort into a lambda probe threaded joint. A corresponding thread can be provided with little effort at any point in the exhaust gas system. A typical, but not necessarily, flat design, which results from the usual use of a plane substrate 1, implies together with the corresponding gas streaming pattern that a gas sensor such as this can be planned for use in an exhaust gas system usually without geometrical restrictions. Therefore the gas sensor S can also be mounted at a position that was previously inaccessible to other exhaust gas probes.

Because the amount of oxygen that reaches the exhaust gas E as a result of the diffusion only amounts to approx. 1/1000 of the volume of the exhaust gas E, the gas sensor can also be installed ahead of a catalytic converter, because the exhaust gas E is scarcely adversely affected in its totality by a small additional amount of oxygen. This opens up the possibility, for example, of performing a differential measurement using two gas sensors S before and after the catalytic converter.

A preferably used gas sensor S which preferably uses a semiconducting metal oxide as the material of the gas-sensitive region 2 is heated to typical temperatures of approx. 700° C. When such a heated gas sensor S is operated in a motor vehicle, an operational readiness for catalytic converter monitoring in accordance with the OBD II standard is important immediately from the time the engine is started. For this purpose, the heating of the sensor can be initiated, for example, by opening of the driver's door, release of the central locking or a load bearing down on the driver's seat.

1. Gas sensor (S), comprising
at least one gas-sensitive region (2) that is applied to a substrate (1),
characterized in that
the substrate (1) comprises at least one diffusion-open section.

2. Gas sensor (S) according to claim 1, wherein the at least one diffusion-open section exhibits a porosity.

3. Gas sensor (S) according to claim 2, wherein the porosity is between 10% and 40%.

4. Gas sensor (5) according to claim 3, wherein the porosity is between 20% and 30%.

5. Gas sensor (S) according to one of the preceding claims, wherein
a gas-tight covering layer (4) is applied indirectly or directly to the substrate (1), said layer covering the gas-sensitive region (2), and, wherein an aperture (5) is present.

6. Gas sensor (S) according to claim 5, wherein a gas-permeable insulating layer (3) is present between the gas-sensitive region (2) and the covering layer (4).

7. Gas sensor (S) according to one of the preceding claims, wherein the gas-sensitive region (2) is implemented in the form of a layer made of semiconducting metal oxide.

8. Gas sensor (5) for detecting hydrocarbons and/or nitric oxides in an exhaust gas (E), wherein at least oxygen can diffuse through the substrate (1).

9. Gas sensor (S) according to claim 8 which can be installed in a wall of an exhaust gas pipe (5) such that the gas-sensitive region (2) can be exposed to an exhaust gas (E) and the porous section of the substrate (1) can be exposed at least partially to the atmosphere surrounding the exhaust gas pipe (5), particularly air.

10. Application of a gas sensor (S) according to one of the claims 8 or 9 for exhaust gas regulation in a motor vehicle or a heating system

11. Method for detecting gas, wherein a gas-sensitive region (2) is exposed to a gas atmosphere that is to be measured, characterized in that at least one interference gas (G) diffuses to the gas-sensitive region (2) through a substrate (1) carrying the gas-sensitive region (2).

12. Method according to claim 11, wherein the interference gas (G) is enriched within a gas-tight covering layer (4) partially covering the gas-sensitive region (2).

13. Method according to claim 12, wherein the interference gas (G) flows from the substrate (1) to at least one aperture (5) that is present in the covering layer (4),
the gas-sensitive region (2) being located in the area of the highest concentration of the interference gas (G).
